(19) United States
(12) Patent Application Publication
(10) Pub. No.: US 2016/0292121 A1
(43) Pub. Date: Oct. 6, 2016

(54) APPARATUS AND METHOD FOR PROCESSING SIGNAL

(71) Applicant: Samsung Electronics Co., Ltd., Gyeonggi-do (KR)

(72) Inventors: Il-Hyung CHUNG, Gyeonggi-do (KR); Cheolho LEE, Gyeonggi-do (KR); Dae-Woong KIM, Gyeonggi-do (KR); Shin-Ho KIM, Gyeonggi-do (KR); Wonseob KIM, Seoul (KR)

(21) Appl. No.: 15/082,408

(22) Filed: Mar. 28, 2016

(30) Foreign Application Priority Data
Apr. 1, 2015 (KR) 10-2015-0046260

(51) Int. Cl. G06F 13/42; G06F 13/40

(52) U.S. Cl. CPC G06F 13/4221; G06F 13/4068

(57) ABSTRACT

A method for use in an electronic device having an interface unit, comprising: selecting a first pin set from a plurality of pin sets that are part of the interface unit, wherein the first pin set is associated with a first communication channel; grounding a second pin set in the plurality of pin sets, wherein the second pin set is associated with a second communication channel; and processing a signal for the first pin set.

### CLAIM OF PRIORITY

This application claims priority under 35 U.S.C. §119(a) to Korean Application Serial No. 10-2015-0046260, which was filed in the Korean Intellectual Property Office on Apr. 1, 2015, the entire content of which is hereby incorporated by reference.

### TECHNICAL FIELD

The present disclosure relates to electronic devices in general, and more particularly to an apparatus and a method for processing a signal in an electronic device.

### BACKGROUND

In general, electronic devices have various functions and can perform a complex function. The electronic devices may access each other and exchange signals. For example, the electronic devices may access each other wirelessly or through a wire. That is, the electronic devices may access each other through a cable. The electronic devices may use various types of interfaces. That is, the electronic devices may include ports, and the ports may be connected through the cable. The ports of the electronic devices may have various interface structures. Accordingly, the electronic devices may exchange signals through the cable.

However, the electronic devices have a problem in that the access is not easy. That is, according to interface structures of the electronic devices, the cable is determined. This is because, for the access of the electronic device, the cable should support all of the interface structures of the electronic devices. Accordingly, if users of the electronic devices do not have proper cables, the electronic devices cannot access each other. Therefore, the use efficiency of the electronic devices is low and the convenience of the users is also low.

### SUMMARY

According to aspects of the disclosure, a method is provided in an electronic device having an interface unit, comprising: selecting a first pin set from a plurality of pin sets that are part of the interface unit, wherein the first pin set is assoicated with a first communication channel; grounding a second pin set in the plurality of pin sets, wherein the second pin set is associated with a second communication channel; and processing a signal for the first pin set.

According to aspects of the disclosure, an apparatus is provided comprising: an interface unit comprising a plurality of pin sets; a signal processing unit for processing a signal; a grounding unit for grounding at least one of the plurlality of pin sets; and at least one controller configured to: select a first pin set from the plurality of pin sets, wherein the first pin set is assoicated with a first communication channel; ground a second pin set in the plurality of pin sets, wherein the second pin set is associated with a second communication channel; and process a signal for the first pin set.

A non-transitory computer-readable medium storing one or more instructions which when executed by an electronic device cause the electronic device to perform a method comprising the steps of: selecting a first pin set from a plurality of pin sets that are part of an interface unit, wherein the first pin set is assoicated with a first communication channel; grounding a second pin set in the plurality of pin sets, wherein the second pin set is associated with a second communication channel; and processing a signal for the first pin set.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram of an example of a communication system, according to aspects of the disclosure;

FIG. 2 is a block diagram of the communication system of FIG. 1, according to aspects of the disclosure;

FIG. 3 is a block diagram of an example of an electronic device, according to aspects of the disclosure;

FIG. 4 is a block diagram of an example of an interface, according to aspects of the disclosure;

FIG. 5 is a block diagram of an example of a controller, according to aspects of the disclosure;

FIG. 6 is a circuit diagram of an example of a connection unit, according to aspects of the disclosure;

FIG. 7 is a flowchart of an example of a process, according to aspects of the disclosure; and

FIG. 8 is a flowchart of an example of a process, according to aspects of the disclosure.

### DETAILED DESCRIPTION

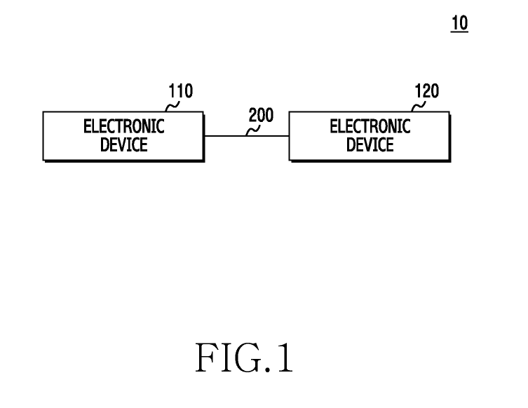

Hereinafter, embodiments of the present disclosure will be described in detail with reference to the accompanying drawings. Here, it is noted that identical reference numerals denote the same structural elements in the accompanying drawings. FIG. 1 is a block diagram of an example of a communication system, according to aspects of the disclosure. More particularly, as illustrated in FIG. 1, a communication system 10 including an electronic device 110 and an electronic device 120. The electronic devices 110 and 120 may be the same or different from each other.

The electronic devices 110 and 120 may connect to each other and exchange signals. The electronic devices 110 and 120 may communicate through a communication network. Additionally or alternatively, the electronic devices 110 and 120 may connect to each other through a wired connection. The electronic devices 110 and 120 may connect to each other through a cable 200. The electronic devices 110 and 120 may have a signal interface structure. The cable 200 may support the single interface structure. For example, when the electronic devices 110 and 120 are the same, the electronic devices 110 and 120 may have the same interface structure. In instances in which the electronic devices 110 and 120 are different, the electronic devices 110 and 120 may have the same interface structure.

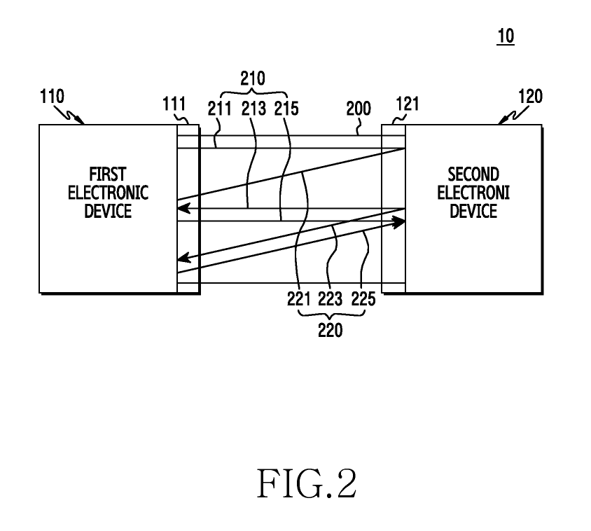

FIG. 2 is a block diagram of the communication system of FIG. 1, according to aspects of the disclosure. More particularly, as illustrated in FIG. 2, the first electronic device 110 and the second electronic device 120 may connect to each other and exchange signals. For example, the first electronic device 110 and the second electronic device 120 may connect to each other via a wired connection. The first electronic device 110 and the second electronic device 120 may connect to each other through the cable 200.

The cable 200 may comport to an interface that is supported by both the first electronic device 110 and the second electronic device 120. In this regard, the first electronic device 110 includes a first interface unit 111 and the second electronic device 120 includes a second interface unit 121. For example, the first interface unit 111 and the second interface unit 121 have a single interface structure. The cable 200 may support the single interface structure. For example, when the first electronic device 110 and the second electronic device 120 are the same, the first interface unit 111 and the second interface unit 121 may have the same interface structure. When the first electronic device 110 and the second electronic device 120 are different, the first interface unit 111 and the second interface unit 121 may have the same interface structure.

Between the first electronic device 110 and the second electronic device 120, a plurality of communication channels 210 and 220 may be formed. That is, the first interface unit 111 and the second interface unit 121 may provide the communication channels 210 and 220. Further, the cable 200 may support the communication channels 210 and 220. The communication channels 210 and 220 may include detection paths 211 and 221, transmission paths 213 and 223, and reception paths 215 and 225, respectively. The detection paths 211 and 221 may be used to detect the connection between the first electronic device 110 and the second electronic device 120 in the communication channels 210 and 220. The transmission paths 213 and 223 may be used to transmit signals from the second electronic device 120 to the first electronic device 110. The reception paths 215 and 225 may be used to transmit signals from the first electronic device 110 to the second electronic device 120.

Further, the first electronic device 110 may use both the communication channels 210 and 220. For example, the first electronic device 110 may use one of the communication channels 210 and 220 to exchange communications with the second electronic device 120. The first electronic device 110 may detect that it is connected to the second electronic device 120 through the detection paths 211 and 221. Further, the first electronic device 110 may receive signals from the second electronic device 120 through the transmission paths 213 and 223. Additionally or alternatively, the first electronic device 110 may transmit signals to the second electronic device 120 through the reception paths 215 and 225.

Additionally or alternatively, the second electronic device 120 may use one of the communication channels 210 and 220. That is, the second electronic device 120 may use one of the communication channels 210 and 220 to exchange communications with the first electronic device 110. The second electronic device 120 may detect that it is connected to the first electronic device 110 through one of the detection paths 211 and 221. Further, the second electronic device 120 may transmit a signal to the first electronic device 110 through one of the transmission paths 213 and 223. Additionally or alternatively, the second electronic device 120 may receive a signal from the first electronic device 110 through one of the reception paths 215 and 225.

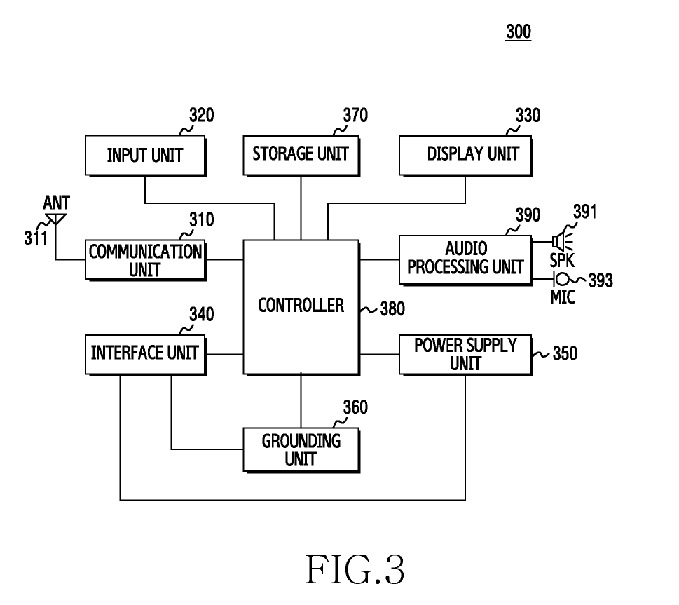

FIG. 3 is a block diagram of an example of an electronic device, according to aspects of the disclosure. More particularly, as illustrated in FIG. 3, a signal processing device 300 according to the present embodiment includes a communication unit 310, an input unit 320, a display unit 330, an interface unit 340, a power supply unit 350, a grounding unit 360, a storage unit 370, a controller 380, and an audio processing unit 390.

The communication unit 310 may include a wireless communication unit. For example, the communication unit 310 may communicate with an external device through various communication schemes. In this regard, the communication unit 310 may connect to at least one of a mobile communication network and a data communication network. Additionally or alternatively, the communication unit 310 may perform short-range communications. The communication unit 310 may include an antenna (ANT) 311. For example, the external device may include an electronic device, a base station, a server, and a satellite. The communication schemes may include Long Term Evolution (LTE), Wideband Code Division Multiple Access (WCDMA), Global System for Mobile Communications (GSM), Wi-Fi, Bluetooth, and Near Field Communications (NFC).

The input unit 320 generates input data in the signal processing device 300. For example, the input unit 320 may generate input data in accordance with a user input of the signal processing unit 300. The input unit 320 may include at least one input means. The input unit 320 may include a keypad, a dome switch, a physical button, a touch panel, a jog & shuttle, and a sensor.

The display unit 330 outputs display data in the signal processing device 300. The display unit 330 may include a Liquid Crystal Display (LCD), a Light Emitting Diode (LED) display, an Organic LED (OLED) display, a Micro Electro Mechanical System (MEMS) display, and an electronic paper display. The display unit 330 may include a plurality of light emitting diodes. The display unit 330 may be coupled with the input unit 320 to be implemented as a touch screen.

The interface unit 340 provides an interface for the signal processing device 300. For example, the interface unit 340 may have a single interface structure. To this end, the interface unit 340 may be connected to the external device through the cable 200.

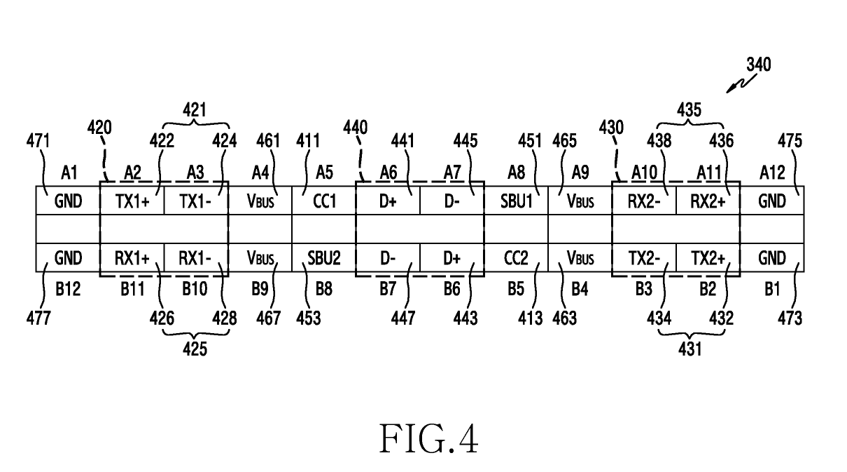

FIG. 4 is a block diagram of an example of an interface, according to aspects of the disclosure. More particularly, as illustrated in FIG. 4, the interface unit 340 of the signal processing device 300 according to the present embodiment may include a plurality of detection pins 411 and 413, a plurality of communication pin sets 420, 430, 440, 451, and 453, a plurality of power supply pins 461, 463, 465, and 467, and a plurality of ground pins 471, 473, 475, and 477. For example, an interface structure of the interface unit 340 is vertically symmetrical and horizontally symmetrical. The interface structure of the interface unit 340 may include twelve columns (labeled A and B) and two rows (labeled 1 through 12), such that pin addresses may be formed by concatenating the pins' respective row and column labels. For example, the pin addresses may include A1, A2, A3, A4, A5, A6, A7, A8, A9, A10, A11, A12, B1, B2, B3, B4, B5, B6, B7, B8, B9, B10, B11, and B12.

The detection pins 411 and 413 are provided to detect a connection to an external device by the signal processing device 300. That is, the detection pins 411 and 413 are provided to determine the respective states of the communication channels 210 and 220. For example, the detection pins 411 and 413 detect the communication channels 210 and 220. When the signal processing device 300 forms the communication channels 210 and 220 with the external device, one of the detection pins 311 and 314 may detect one of the communication channels 210 and 220.

The detection pins 411 and 413 include a first detection pin 411 and a second detection pin 413. The first detection pin 411 and the second detection pin 413 are vertically and horizontally symmetrical with respect to the center of the interface unit 340. For example, the first detection pin 411 and the second detection pin 413 may be arranged in A5 and B5. One of the first detection pin 411 or the second detection pin 413 may be an active detection pin, and the other may be an inactive detection pin. The active detection pin may be activated to indicate that one of the communication channels 210 and 220 are used to form a connection with an external device. The active detection pin may identify the first communication channel 210 and the second communication channel 220. For example, the active detection pin may detect that one of the first communication channel 210 and the second communication channel 220 are used to form a connection with an external device. The inactive detection pin may be deactivated and may not be used for detecting the state of the communication channels 210 and 220.

The communication pin sets 420, 430, 440, 451, and 453 are provided to exchange signals in the signal processing device 300. That is, the communication pin sets 420, 430, 440, 451, and 453 transmit or receive signals. For example, at least one of the communication pin sets 420, 430, 440, 451, and 453 may transmit or receive signals.

The communication pin sets 420, 430, 440, 451, and 453 may include a first communication pin set 420, a second communication pin set 430, a third communication pin set 440, and fourth communication pin sets 451 and 453. The first communication pin set 420 and the second communication pin set 430 may have the same transmission rate. Additionally or alternatively, the third communication pin set 440 and the fourth communication pin sets 451 and 453 may have transmission rates that are different from those of the first communication pin set and the second communication pin set.

The first communication channel 210 may be allocated to the first communication pin set 420. The first communication pin set 420 may include a first transmission pin set 421 and a first reception pin set 425. The first communication pin set 420 may have a predetermined transmission rate. The first transmission pin set 421 may include a first positive transmission pin 422 and a first negative transmission pin 424. The first reception pin set 425 may include a first positive reception pin 426 and a first negative reception pin 428. The first transmission pin set 421 may transmit signals through the first communication channel 210. The first positive transmission pin 422 may transmit a positive type signal through the first transmission path 213, and the first negative transmission pin 424 may transmit a negative type signal through the first transmission path 213. Additionally or alternatively, the first reception pin set 425 may receive signals through the first communication channel 210. The first positive reception pin set 426 may receive a positive type signal through the first reception path 215, and the first negative reception pin 428 may receive a negative type signal through the first reception path 215.

The second communication channel 220 may be allocated to the second communication pin set 430. The second communication pin set 430 may include a second transmission pin set 431 and a second reception pin set 435. The second communication pin set 430 may have the same transmission rate as that of the first communication pin set 420. The second transmission pin set 431 may include a second positive transmission pin 432 and a second negative transmission pin 434. The second reception pin set 435 may include a second positive reception pin 436 and a second negative reception pin 438. The second transmission pin set 431 may transmit signals through the second communication channel 220. The second positive transmission pin 432 may transmit a positive type signal through the second transmission path 223, and the second negative transmission pin 434 may transmit a negative type signal through the second transmission path 223. Additionally or alternatively, the second reception pin set 435 may receive signals through the second communication channel 220. The second positive reception pin 436 may receive a positive type signal through the second reception path 225, and the second negative reception pin 438 may receive a negative type signal through the second reception path 225.

The first communication pin set 420 and the second communication pin set 430 are vertically and horizontally symmetrical with respect to the center of the interface unit 340. That is, the first transmission pin set 421 and the second transmission pin set 431 may be vertically and horizontally symmetrical with respect to the center of the interface unit 340. More specifically, the first positive transmission pin 422 and the second positive transmission pin 432 may be vertically and horizontally symmetrical with respect to the center of the interface unit 340, and the first negative transmission pin 424 and the second negative transmission pin 434 may be vertically and horizontally symmetrical with respect to the center of the interface unit 340. For example, the first positive transmission pin 422 and the second positive transmission pin 432 may be arranged in A2 and B2, and the first negative transmission pin 424 and the second negative transmission pin 434 may be arranged in A3 and B3. Further, the first reception pin set 425 and the second reception pin set 435 may be vertically and horizontally symmetrical with respect to the center of the interface unit 340. More specifically, the first positive reception pin 426 and the second positive reception pin 436 may be vertically and horizontally symmetrical with respect to the center of the interface unit 340, and the first negative reception pin 428 and the second negative reception pin 438 may be vertically and horizontally symmetrical with respect to the center of the interface unit 340. For example, the first positive reception pin 426 and the second positive reception pin 436 may be arranged in B11 and A11, and the first negative reception pin 428 and the second negative reception pin 438 may be arranged in B10 and A10.

A third communication channel (not shown) may be allocated to the third communication pin set 440. The third communication channel may be different from the first communication channel 210 and the second communication channel 220. The third communication pin set 440 may have a transmission rate different from that of the first communication pin set 420 and the second communication pin set 430. The third communication pin set 440 may include two positive communication pins 441 and 443 and two negative communication pins 445 and 447. The positive communication pins 441 and 443 may transmit and receive positive type signals through the third communication channels. The negative communication pins 445 and 447 may transmit and receive negative type signals through the third communication channel. The positive communication pins 441 and 443 may be vertically and horizontally symmetrical with respect to the center of the interface unit 340. For example, the positive communication pins 441 and 443 may be arranged in A6 and B6. Further, the negative communication pins 445 and 447 may be vertically and horizontally symmetrical with respect to the center of the interface unit 340. For example, the negative communication pins 445 and 447 may be arranged in A7 and B7.

The fourth communication pin sets 451 and 453 in the signal processing device 300 support the interface with the external device. The fourth communication pin sets 451 and 453 may support the third communication pin set 440. That is, when the third communication pin set 440 transmits or receives a signal, the fourth communication pin sets 451 and 453 may transmit or receive an additional signal. Thus, in some implementations, the fourth communication pin sets 451 and 453 may have the same transmission rate as that of the third communication pin set. The fourth communication pin sets 451 and 453 may include a first sub pin 451 and a second sub pin 453. The first sub pin 451 and the second sub pin 453 may be vertically and horizontally symmetrical with respect to the center of the interface unit 340. For example, the first sub pin 451 and the second sub pin 453 may be arranged in A8 and B8. The power supply pins 461, 463, 465, and 467 are provided to receive power in the signal processing device 300. The power supply pins 461, 463, 465, and 467 may receive power for driving the signal processing device 300. The power supply pins 461, 463, 465, and 467 may be vertically and horizontally symmetrical with respect to the center of the interface unit 340. For example, the power supply pins 461, 463, 465, and 467 may be arranged in A4, A9, B4, and B9.

The ground pins 471, 473, 475, and 477 may be provided for a ground connection in the signal processing device 300. The ground pins 471, 473, 475, and 477 may ground the detection pins 411 and 413 and the power supply pins 461, 463, 465, and 467. The ground pins 471, 473, 475, and 477 may be vertically and horizontally symmetrical with respect to the center of the interface unit 340. For example, the ground pins 471, 473, 475, and 477 may be arranged in A1, A12, B1, and B12.

The power supply unit 350 supplies power to the signal processing device 300. The power supply unit 350 may receive power from the power supply pins 461, 463, 465, and 467 of the interface unit 340. Further, the power supply unit 350 may supply power to the components of the signal processing device 300.

The grounding unit 360 grounds the signal processing device 300. The grounding unit 360 may ground the elements of the signal processing device 300. Further, the grounding unit 360 may be connected to the ground pins 471, 473, 475, and 477 of the interface unit 340.

The storage unit 370 may include any suitable type of volatile or non-volatile memory, such as Random-access Memory (RAM), Read-Only Memory (ROM),

Network Accessible Storage (NAS), cloud storage, a Solid State Drive (SSD), etc. The storage unit 370 stores operation programs of the signal processing device 300. The storage unit 370 may store a program for processing a signal of one of the communication channels 210 and 220. The storage unit 370 may store a program for connecting the other communication channel 210 or 220 to the grounding unit 360. In some implementations, the storage unit 370 may store data generated during the execution of the operation programs.

The controller 380 may include any suitable type of processing circuitry, such as one or more general-purpose processors (e.g., ARM-based processors), a Digital Signal Processor (DSP), a Programmable Logic Device (PLD), an Application-Specific

Integrated Circuit (ASIC), a Field-Programmable Gate Array (FPGA), etc. In operation, the controller 380 may transmit or receive a signal through at least one of the communication pin sets 420, 430, 440, 451, and 453. To this end, the controller 380 may select one of the first communication pin set 420, the second communication pin set 430, and the third communication pin set 440. When the third communication pin set 440 is selected, the controller 380 may determine whether to use the fourth communication pin sets 451 and 453.

The controller 380 may determine the states of the communication channels 210 and 220. The controller 380 may detect the state of one of the first communication channel 210 and the second communication channel 220 through the detection pins 411 and 413 of the interface unit 340. In response to the detection, the controller 380 may select one of the first communication pin set 420 and the second communication pin set 430. The controller 380 may ground the other communication pin set 420 or 430. The controller 380 may process (e.g., generate) a signal for transmission over one of the first communication pin set 420 and the second communication pin set 430.

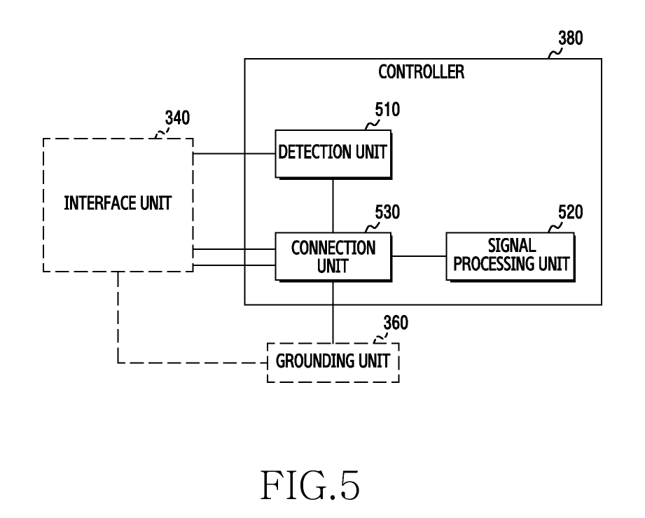

FIG. 5 is a block diagram of an example of a controller, according to aspects of the disclosure. More particularly, as illustrated in FIG. 5, the controller 380 of the signal processing device 300 according to the present embodiment may include a detection unit 510, a signal processing unit 520, and a connection unit 530.

The detection unit 510 may detect the states of the communication channels 210 and 220. The detection unit 510 may detect the states of the communication channels 210 and 220 by using the detection pins 411 and 413 of the interface unit 340. The detection unit 510 may detect the states of the communication channels 210 and 220 through one of the detection pins 411 and 413, for example, the active detection pin. Accordingly, the detection unit 510 detects one of the communication channels 210 and 220. When the signal processing device 300 forms the communication channels 210 and 220 with the external device, the active detection pin may detect one of the communication channels 210 and 220.

Further, the detection unit 510 may select one of the first communication pin set 420 and the second communication pin set 430. When the first communication channel 210 is detected, the detection unit 510 may select the first communication pin set 420. Additionally or alternatively, when the second communication channel 220 is detected, the detection unit 510 may select the second communication pin set 430. The detection unit 510 may generate a selection signal indicating the selection. The detection unit 510 may generate a first selection signal when the first communication pin set 420 is selected and a second selection signal when the second communication pin set 430 is selected. For example, the first selection signal may be a high signal and the second selection signal may be a low signal.

The signal processing unit 520 may process a signal for one of the communication channels 210 and 220. The signal processing unit 520 may process a signal to be transmitted to one of the communication channels 210 and 220. Additionally or alternatively, the signal processing unit 520 may process a signal received from one of the communication channels 210 and 220. The signal processing unit 520 may include a transmitter for encoding and modulating the signal to be transmitted and a receiver for demodulating and decoding the signal. The signal processing unit 520 may include a MODEM and a CODEC. The CODEC may include a data CODEC for processing packet data and the like, and an audio CODEC for processing an audio signal such as a voice and the like.

The connection unit 530 controls connections for the communication channels 210 and 220. That is, the connection unit 530 controls connections between the first communication pin set 420, the second communication pin set 430, the signal processing unit 520, and the grounding unit 360. The connection unit 530 may connect one of the first communication pin set 420 and the second communication pin set 430 to the signal processing unit 520. The connection unit 530 may connect the other communication pin set 420 or 430 to the grounding unit 360. When the detection unit 510 selects the first communication pin set 420, the connection unit 530 may connect the first communication pin set 420 to the signal processing unit 520 and the second communication pin set 430 to the grounding unit 360. Additionally or alternatively, when the detection unit 510 selects the second communication pin set 430, the connection unit 530 may connect the second communication pin set 430 to the signal processing unit 520 and the first communication pin set 420 to the grounding unit 360. For example, the connection unit 530 may include a switching device.

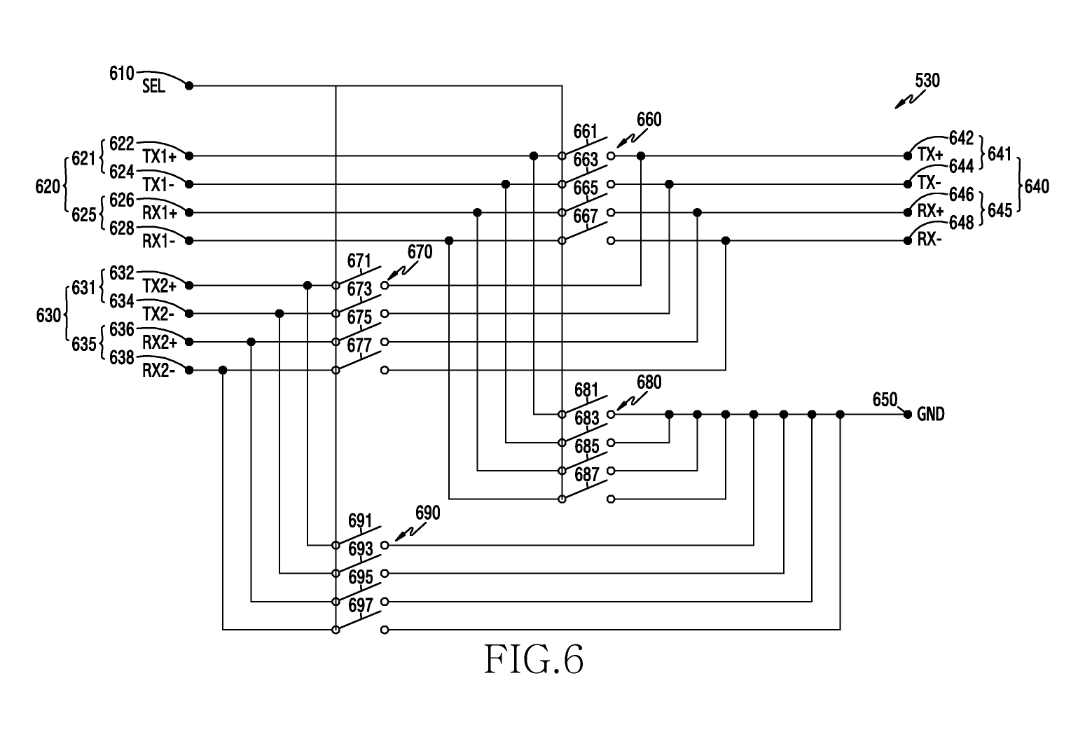

FIG. 6 is a circuit diagram of an example of a connection unit, according to aspects of the disclosure. More particularly, as illustrated in FIG. 6, the connection unit 530 may include a detection terminal 610, a first communication terminal set 620, a second communication terminal set 630, a connection terminal set 640, a ground terminal 650, a first connection switch set 660, a second connection switch set 670, a first ground switch set 680, and a second ground switch set 690.

The detection terminal 610 may be connected to the detection unit 510. The detection terminal 610 may receive a signal from the detection unit 510 in accordance with one of the first communication pin set 420 and the second communication pin set 430. The selection signal may include a first selection signal corresponding to the first communication pin set 420 and a second selection signal corresponding to the second communication pin set 430. For example, the first selection signal may be a high-level signal and the second selection signal may be a low signal.

The first communication terminal set 620 may be connected to the first communication pin set 420 of the interface unit 340. The first communication terminal set 620 may include a first transmission terminal set 621 and a first reception terminal set 625. The first transmission terminal set 621 may include a first positive transmission terminal 622 and a first negative transmission terminal 624. The first reception terminal set 625 may include a first positive reception terminal 626 and a first negative reception terminal 628. The first transmission terminal set 621 may be connected to the first transmission pin set 421. The first positive transmission terminal 622 may be connected to the first positive transmission pin 422, and the first negative transmission terminal 624 may be connected to the first negative transmission pin 424. Additionally or alternatively, the first reception terminal set 625 may be connected to the first reception pin set 425. The first positive reception terminal 626 may be connected to the first positive reception pin 426, and the first negative reception terminal 628 may be connected to the first negative reception pin 428.

The second communication terminal set 630 may be connected to the second communication pin set 430 of the interface unit 340. The second communication terminal set 630 may include a second transmission terminal set 631 and a second reception terminal set 635. The second transmission terminal set 631 may include a second positive transmission terminal 632 and a second negative transmission terminal 634. The second reception terminal set 635 may include a second positive reception terminal 636 and a second negative reception terminal 638. The second transmission terminal set 631 may be connected to the second transmission pin set 621. The second positive transmission terminal 632 may be connected to the second positive transmission pin 432, and the second negative transmission terminal 634 may be connected to the second negative transmission pin 434. Additionally or alternatively, the second reception terminal set 635 may be connected to the second reception pin set 435. The second positive reception terminal 636 may be connected to the second positive reception pin 436, and the second negative reception terminal 638 may be connected to the second negative reception pin 438.

The connection terminal set 640 may be connected to the signal processing unit 520. The connection terminal set 640 may include an output terminal set 641 and an input terminal set 645. The output terminal set 641 may include a positive output terminal 642 and a negative output terminal 644. The input terminal set 645 may include a positive input terminal 646 and a negative input terminal 648.

The ground terminal 650 may be connected to the grounding unit 360.

The first connection switch set 660 may be disposed between the first communication terminal set 620 and the connection terminal set 640. The first connection switch set 660 may include a first positive output switch 661, a first negative output switch 663, a first positive input switch 665, and a first negative input switch 667. The first positive output switch 661 may be arranged between the first positive transmission terminal 622 and the positive output terminal 642, and the first negative output switch 663 may be arranged between the first negative transmission terminal 624 and the negative output terminal 644. The first positive input switch 665 may be arranged between the first positive reception terminal 626 and the positive input terminal 646, and the first negative input switch 667 may be arranged between the first negative reception terminal 628 and the negative input terminal 648.

The first connection switch set 660 may connect the first communication terminal set 620 to the connection terminal set 640 or release the connection between the first communication terminal set 620 and the connection terminal set 640 in accordance with the selection signal of the detection unit 510. That is, when the first selection signal is received through the detection terminal 610, the first connection switch set 660 may be closed and may connect the first communication terminal set 620 to the connection terminal set 640. The first positive output switch 661, the first negative output switch 663, the first positive input switch 665, and the first negative input switch 667 may be collectively closed. Additionally or alternatively, when the second selection signal is received through the detection terminal 610, the first connection switch set 660 may be opened and may release the connection between the first communication terminal set 620 and the connection terminal set 640. The first positive output switch 661, the first negative output switch 663, the first positive input switch 665, and the first negative input switch 667 may be collectively opened.

The second connection switch set 670 may be disposed between the second communication terminal set 630 and the connection terminal set 640. The second connection switch set 670 may include a second positive output switch 671, a second negative output switch 673, a second positive input switch 675, and a second negative input switch 677. The second positive output switch 671 may be disposed between the second positive transmission terminal 632 and the positive output terminal 642, and the second negative output switch 673 may be disposed between the second negative transmission terminal 634 and the negative output terminal 644. The second positive input switch 675 may be disposed between the second positive reception terminal 636 and the positive input terminal 646, and the second negative input switch 677 may be disposed between the second negative reception terminal 638 and the negative input terminal 648.

The second connection switch set 670 may connect the second communication terminal set 630 to the connection terminal set 640 or release the connection between the second communication terminal set 630 and the connection terminal set 640 in accordance with the selection signal of the detection unit 510. That is, when the first selection signal is received through the detection terminal 610, the second connection switch set 670 may be opened and may release the connection between the second communication terminal set 630 and the connection terminal set 640. The second positive output switch 671, the second negative output switch 673, the second positive input switch 675, and the second negative input switch 667 may be collectively opened. Additionally or alternatively, when the second selection signal is received through the detection terminal 610, the second connection switch set 670 may be closed and may connect the second communication terminal set 630 and the connection terminal set 640. The second positive output switch 671, the second negative output switch 673, the second positive input switch 675, and the second negative input switch 667 may be collectively closed.

The first ground switch set 680 may be disposed between the first communication terminal set 620 and the ground terminal 650. The first ground switch set 680 may include a plurality of first ground switches 681, 683, 685, and 687. The first ground switches 681, 683, 685, and 687 may be disposed between the first positive transmission terminal 622 and the ground terminal 650, between the first negative transmission terminal 624 and the ground terminal 650, between the first positive reception terminal 626 and the ground terminal 650, and between the first negative reception terminal 628 and the ground terminal 650.

The first ground switch set 680 may connect the first communication terminal set 620 to the ground terminal 650 or release the connection between the first communication terminal set 620 and the ground terminal 650 in accordance with the selection signal of the detection unit 510. That is, when the first selection signal is received through the detection terminal 610, the first ground switch set 680 may be opened and may release the connection between the first communication terminal set 620 and the ground terminal 650. The first ground switches 681, 683, 685, and 687 may be collectively opened. Additionally or alternatively, when the second selection signal is received through the detection terminal 610, the first ground switch set 680 may be closed and may connect the first communication terminal set 620 and the ground terminal 650. The first ground switches 681, 683, 685, and 687 may be collectively closed.

The second ground switch set 690 may be disposed between the second communication terminal set 630 and the ground terminal 650. The second ground switch set 690 may include a plurality of second ground switches 691, 693, 695, and 697. The second ground switches 691, 693, 695, and 697 may be disposed between the second positive transmission terminal 632 and the ground terminal 650, between the second negative transmission terminal 634 and the ground terminal 650, between the second positive reception terminal 636 and the ground terminal 650, and between the second negative reception terminal 638 and the ground terminal 650.

The second ground switch set 690 may connect the second communication terminal set 630 to the ground terminal 650 or release the connection between the second communication terminal set 630 and the ground terminal 650 in accordance with the selection signal of the detection unit 510. Additionally or alternatively, when the first selection signal is received through the detection terminal 610, the second connection switch set 690 may be closed and may connect the second communication terminal set 630 and the ground terminal 650. The second ground switches 691, 693, 695, and 697 may be collectively closed. Additionally or alternatively, when the second selection signal is received through the detection terminal 610, the second connection switch set 690 may be opened and may connect the second communication terminal set 630 and the ground terminal 650. The second ground switches 691, 693, 695, and 697 may be collectively opened.

The audio processing unit 390 may process an audio signal. For example, the audio processing unit 390 includes a speaker (SPK) 391 and a microphone (MIC) 393. That is, the audio processing unit 390 may reproduce the audio signal through the speaker 391. The audio processing unit 390 may collect the audio signal through the microphone 393.

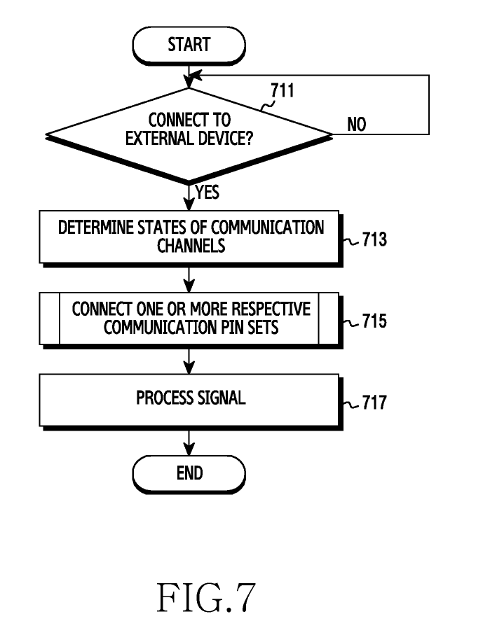

FIG. 7 is a flowchart of an example of a process, according to aspects of the disclosure. More particularly, as illustrated in FIG. 7, the signal processing method according to the present embodiment starts detecting a connection with an external device by the controller 380 in operation 711. For example, the interface unit 340 may be connected to the external device. The interface unit 340 may be connected to the external device through the cable 200. When the interface unit 340 is connected to the external device, the controller 380 may detect the connection to the external device through one of the detection pins 411 and 413. The detection unit 510 may detect the connection of the external device by using the active detection pin. For example, when the interface unit 340 is connected to the external device, one of the communication channels 210 and 220 may be established between the active detection pin and the external device. When one of the communication channels 210 and 220 is formed, an impedance change may be generated in the active detection pin. Accordingly, the detection unit 510 detects the impedance change in the active detection pin and thus detects the connection of the external device.

Subsequently, when the connection of the external device is detected in operation 711, the controller 380 detects the respective states of the communication channels 210 and 220 in operation 713. The controller 380 may detect the respective states of the communication channels 210 and 220 through one of the detection pins 411 and 413. The detection unit 510 may identify the first communication channel 210 and the second communication channel 220 through the active detection pin. Further, the detection unit 510 may detect one of the first communication channel 210 and the second communication channel 220 through the active detection pin.

Subsequently, the controller 380 controls connections of the communication pin sets 420, 430, 440, 451, and 453 in operation 715. That is, the controller 380 controls the connections of the first communication pin set 420 and the second communication pin set 430 according to the states of the communication channels 210 and 220. For example, the connection unit 530 may control connections between the first communication pin set 420, the second communication pin set 430, the signal processing unit 520, and the grounding unit 360. The connection unit 530 may connect one of the first communication pin set 420 and the second communication pin set 430 to the signal processing unit 520. The connection unit 530 grounds the other communication pin set 420 or 430.

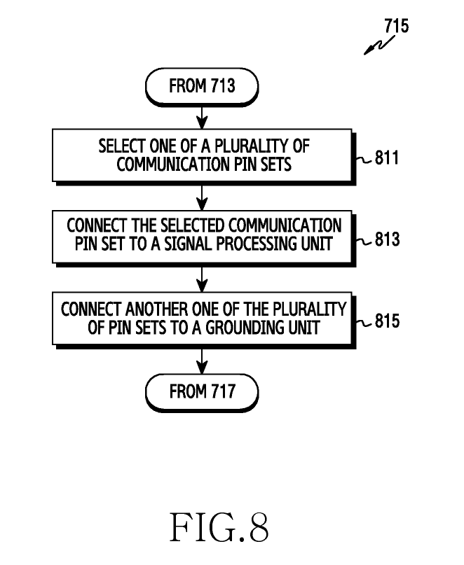

FIG. 8 is a flowchart of an example of a process, according to aspects of the disclosure. More particularly, as illustrated in FIG. 8, the controller 380 may select one of the communication pin sets 420, 430, 440, 451, and 453 in operation 811. The controller 380 may select one of the first communication pin set 420 and the second communication pin set 430 according to the states of the communication channels 210 and 220. The detection unit 510 may select one of the first communication pin set 420 and the second communication pin set 430 in accordance with one of the first communication channel 210 and the second communication channel 220. That is, when the first communication channel 210 is detected, the detection unit 510 may select the first communication pin set 420. Additionally or alternatively, when the second communication channel 220 is detected, the detection unit 510 may select the second communication pin set 430.

The detection unit 510 may generate a selection signal in accordance with one of the first communication pin set 420 and the second communication pin set 430. For example, when the first communication pin set 420 is selected, the detection unit 510 may generate a first selection signal. As another example, when the second communication pin set 430 is selected, the detection unit 510 may generate a second selection signal. Further, the detection unit 510 may output the selection signal to the detection terminal 610 of the connection unit 530.

Next, the controller 380 connects the selected one of the communication pin sets 420, 430, 440, 451, and 453 to the signal processing unit 520 in operation 813. For example, the controller 380 connects one of the first communication set 420 and the second communication pin set 430 to the signal processing unit 520. That is, when the first communication pin set 420 is selected, the connection unit 530 may connect the first communication pin set 420 to the signal processing unit 520. Additionally or alternatively, when the second communication pin set 430 is selected, the connection unit 530 may connect the second communication pin set 430 to the signal processing unit 520.

The connection unit 530 may connect one of the first communication pin set 420 and the second communication pin set 430 to the signal processing unit 520 in accordance with the selection signal of the detection unit 510. For example, when the first selection signal is received through the detection terminal 610, the first connection switch set 660 may be closed and the second connection switch set 670 may be opened. Accordingly, the first connection switch set 660 may connect the first communication terminal set 620 and the connection terminal set 640, and the second connection switch set 670 may release the connection between the second communication terminal set 630 and the connection terminal set 640. Additionally or alternatively, when the second selection signal is received through the detection terminal 610, the first connection switch set 660 may be opened and the second connection switch 670 set may be closed. Accordingly, the first connection switch set 660 may release the connection between the first communication terminal set 620 and the connection terminal set 640, and the second connection switch set 670 may connect the second communication terminal set 630 to the connection terminal set 640.

Next, the controller 380 connects one or more of the remaining communication pin sets of the communication pin sets 420, 430, 440, 451, and 453 to the grounding unit 360 in operation 815. The controller 380 may connect the other communication pin set 420 or 430 to the grounding unit 360. That is, when the first communication pin set 420 is selected, the connection unit 530 may connect the second communication pin set 430 to the grounding unit 360. Additionally or alternatively, when the second communication pin set 430 is selected the connection unit 530 may connect the first communication pin set 420 to the grounding unit 360. Thereafter, the controller 380 may proceed to operation 717.

The connection unit 530 may connect the other communication pin set 420 or 430 to the grounding unit 360 in accordance with the selection signal of the detection unit 510. For example, when the first selection signal is received through the detection terminal 610, the first ground switch set 680 may be opened and the second ground switch set 690 may be closed. Accordingly, the first ground switch set 680 may release the connection between the first communication terminal set 620 and the ground terminal 650, and the second ground switch set 690 may connect the second communication terminal set 630 and the ground terminal 650. Additionally or alternatively, when the second selection signal is received through the detection terminal 610, the first ground switch set 680 may be closed and the second ground switch 690 set may be opened. Accordingly, the first ground switch set 680 may connect the first communication terminal set 620 and the ground terminal 650, and the second ground switch set 690 may release the connection between the second communication terminal set 630 and the ground terminal 650.

Lastly, the controller 380 processes a signal for one of the communication pin sets 420, 430, 440, 451, and 453 and process/transmits the signal, in operation 717. That is, the controller 380 may process a signal for one of the communication channels 210 and 220. When the first communication pin set 420 is connected to the signal processing unit 520, the signal processing unit 520 may process a signal the first communication channel 210. The signal processing unit 520 may transmit the signal to the first communication channel 210 or receive the signal from the first communication channel 210 through the first communication pin set 420. Additionally or alternatively, when the second communication pin set 430 is connected to the signal processing unit 520, the signal processing unit 520 may process a signal for the second communication channel 220. The signal processing unit 520 may transmit the signal to the second communication channel 220 or receive the signal from the second communication channel 220 through the second communication pin set 430.

The signal processing unit 520 may process the signal and output the processed signal through the output terminal set 640 of the connection unit 530. For example, when the first connection switch set 660 is closed and the second connection switch set 670 is opened, the signal may be transmitted to the first transmission terminal set 621 from the output terminal set 641 and transmitted through the first transmission set 421. Additionally or alternatively, when the first connection switch set 660 is opened and the second connection switch set 670 is closed, the signal may be transmitted to the second transmission terminal set 631 from the output terminal set 641 and transmitted through the second transmission set 431. Additionally or alternatively, the signal processing unit 520 may receive the signal through the input terminal set 645 of the connection unit 530 and process the received signal. For example, when the first connection switch set 660 is closed and the second connection switch set 670 is opened, the signal may be received through the first reception pin set 425 and transferred to the input terminal set 645 from the first reception terminal set 625. Additionally or alternatively, when the first connection switch set 660 is opened and the second connection switch set 670 is closed, the signal may be received through the second reception pin set 435 and transferred to the input terminal set 645 from the second reception terminal set 635.

When processing a signal for one of the communication pin sets 420, 430, 440, 451, and 453, the signal processing device 300 may ground the remaining communication pin sets of the communication pin sets 420, 430, 440, 451, and 453. Accordingly, the signal processing device 300 may prevent electromagnetic interference between the communication pin sets 420, 430, 440, 451, and 453. That is, the signal processing device 300 may prevent the signal from flowing into the remaining communication pin sets of the communication pin sets 420, 430, 440, 451, and 453. Further, the signal processing device 300 may suppress electromagnetic connections between the communication pin sets 420, 430, 440, 451, and 453 and the antenna 311. That is, the signal processing device 300 may prevent the signal from flowing into the antenna 311 through the remaining communication pin sets of the communication pin sets 420, 430, 440, 451, and 453. Accordingly, the capability of the interface of the signal processing device 300 can be improved.

Therefore, because the electronic devices 100, 110, and 120 have the single interface structure in the communication system 10, the electronic devices 100, 110, and 120 can connect to each other. Accordingly, users of the electronic devices 100, 110, and 120 can easily connect the electronic devices 100, 110, and 120 through the single cable 200. As a result, the use efficiency and the convenience of the users of the electronic devices 100, 110, and 120 can be improved.

FIGS. 1-8 are provided as an example only. At least some of the operations discussed with respect to these figures can be performed concurrently, performed in different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

Moreover, the embodiments disclosed in this specification are suggested for the description and understanding of technical content but do not limit the range of the present disclosure. Accordingly, the range of the present disclosure should be interpreted as including all modifications or various other embodiments based on the technical idea of the present disclosure.

What is claimed is:

1. A method in an electronic device having an interface unit, comprising:
selecting a first pin set from a plurality of pin sets that are part of the interface unit, wherein the first pin set is assoicated with a first communication channel;
grounding a second pin set in the plurality of pin sets, wherein the second pin set is associated with a second communication channel; and
processing a signal for the first pin set.

2. The method of claim 1, wherein the first communication channel and the second communication channel have an equal transmission rate.

3. The method of claim 1, further comprising
connecting the first pin set to a signal processing unit,
wherein the signal is processed by the signal processing unit.

4. The method of claim 3, wherein grounding the second pin set comprises connecting the second pin set to a grounding unit.

5. The method of claim 1, the first pin set is selected based on respective states of the first communication channel and the second communication channel.

6. The method of claim 1, further comprising establishing a connection with an external device by using the interface unit.

7. The method of claim 6, wherein the interface unit includes a plurality of detection pins for detecting a connection with one of the first communication channel and the second communication channel.

8. The method of claim 7, wherein one of the detection pins is designated as an active detection pin that is activated when the connection with one of the first communication channel and the second communication channel is established.

9. The method of claim 8, wherein the first communication channel is selected by using the active detection pin.

10. The method of claim 1, wherein each of the first pin set and the second pin set comprises a respective transmission pin set and a respective reception pin set.

11. An apparatus comprising:
an interface unit comprising a plurality of pin sets;
a signal processing unit for processing a signal;
a grounding unit for grounding at least one of the plurality of pin sets; and
at least one controller configured to:
select a first pin set from the plurality of pin sets, wherein the first pin set is associated with a first communication channel;
ground a second pin set in the plurality of pin sets, wherein the second pin set is associated with a second communication channel; and
process the signal for the first pin set.

12. The apparatus of claim 11, wherein the at least one controller is further configured to connect any of the first pin set and the second pin set to the signal processing unit or the grounding unit according to states of the first communication channel and the second communication channel.

13. The apparatus of claim 11, wherein the interface unit includes a plurality of detection pins for detecting a connection with one of the first communication channel and the second communication channel.

14. The apparatus of claim 13, wherein one of the detection pins is designated as an active detection pin that is activated when the connection with one of the first communication channel and the second communication channel is established.

15. The apparatus of claim 14, wherein the at least one controller is further configured to detect that the first communication channel is connected to an external device by using the active detection pin.

16. The apparatus of claim 15, wherein the at least one controller comprises a connection unit configured to connect the first pin set to the signal processing unit.

17. The apparatus of claim 16, wherein the connection unit comprises a switch device.

18. The apparatus of claim 17, wherein the at least one controller is further configured to apply to the switch device a high signal for connecting the first pin set to the signal processing unit and a low signal for connecting the second pin set to the signal processing unit.

19. The apparatus of claim 11, wherein each of the first pin set and the second pin set comprises a respective transmission pin set and a respective reception pin set.

20. A non-transitory computer-readable medium storing one or more instructions which when executed by an electronic device cause the electronic device to perform a method comprising the steps of:
selecting a first pin set from a plurality of pin sets that are part of an interface unit, wherein the first pin set is associated with a first communication channel;
grounding a second pin set in the plurality of pin sets, wherein the second pin set is associated with a second communication channel; and
processing a signal for the first pin set.
